(19) United States
(12) Patent Application Publication
(10) Pub. No.: US 2011/0080845 A1
(43) Pub. Date: Apr. 7, 2011

(54) Intelligent Node-Matching And Control Configuration For The Wireless Network

(75) Inventors: Chun-Hsu Su, Taipei County (TW); Ren-Peng Chen, Taipei County (TW)

(73) Assignees: Chun-Hsu Su, Taipei County (TW); Ren-Peng Chen, Taipei County (TW)

(21) Appl. No.: 12/574,705

(22) Filed: Oct. 7, 2009

(51) Int. Cl. H04L 12/28

(52) U.S. Cl. 370/254

(57) ABSTRACT

The present invention is a configuration to detect and control the wireless network inside a building that fixes the location of networking device inside the building; wherein, the networking device consists of a gateway, a server and a LAN coordinator while the networking device is installed at the network exit end of the building for the gateway to be linked with the supply device from external network; then a plurality of wireless network nodes equipped with a transmit/receive unit, a indicating unit and a power supply unit are taken, irregularly distributed and erected in the building; furthermore, every wireless network node can be interconnected to the LAN coordinator while the wireless network nodes are interconnected with one another as well. Thus a configuration can not only enhance the reliability of linking signals for the wireless network, but also facilitate the nodes within the wireless network to accomplish thereof performance of simple installation and reconditioning.

### BACKGROUND OF THE INVENTION

1. Field of the Invention

The present invention relates generally to an intelligent node-matching and control configuration for wireless network, and more particularly to a configuration that can not only simplify and shorten the authentication time for each node in the wireless network, but also keep away the interference from the adjacent network segments in order to promote the security and make the functions of administration, transmission, detection and control for a truly private network achievable.

2. Description of the Prior Art

As a rule, the conventional node-matching and control configuration for the wireless network is to have two RF modules in different frequency bands, different PAN (Personal Area Network) and different powers embedded together without an action of mutual authentication for both sides to segment the nodes in the wireless network having the same ID code; also the same node in the wireless network will not provide two identical RF module technologies (such as: gsm+wifi, wimax+3 g, etc.); and in spite of the existing control for the nodes in the wireless network can have the ID code for prevention of error authentication; still it just has an ability of comparison and lacks of two-way authentication and filtration; thus, every node in the wireless network can not but has a longer time for authentication, and is easily received the interactive interference from the adjacent wireless networks that may cause error action and lead to an occurrence of weakened security.

### SUMMARY OF THE INVENTION

The primary objective of the present invention is to not only simplify and shorten the authentication time for each node in wireless network, but also keep away the interference from the adjacent network segments in order to promote the security and make the functions of administration, transmission, detection and control for a truly private network is achievable.

The foregoing objective of the present invention is attained by an intelligent node-matching and control configuration for the wireless network comprising a server mechanism that is comprised of a first antenna, a second antenna, authentication unit, logic operation unit and control unit; wherein, the first antenna can be used for authentication, the second antenna can be used for signal transmission, the authentication unit can be used to generate relevant ID codes, the logic operation unit can process the received information, and the control unit can take the transmission signals to perform action or operation instruction; a supply device that can be connected to the server mechanism and the supply device of an external network; a plurality of nodes in the wireless network that every node in the wireless network is able to access a handshaking communication with the first antenna and operate in cooperation with the second antenna to proceed the signal transmission provided that the node in the wireless network has passed the authentication by the authentication unit and interconnected with the server mechanism.

### BRIEF DESCRIPTION OF THE FIGURES

FIG. 1, is a schematic diagram of basic configuration for the present invention.

FIG. 2, is a schematic block diagram for the present invention.

### DETAILED DESCRIPTION OF THE PREFERRED EMBODIMENTS

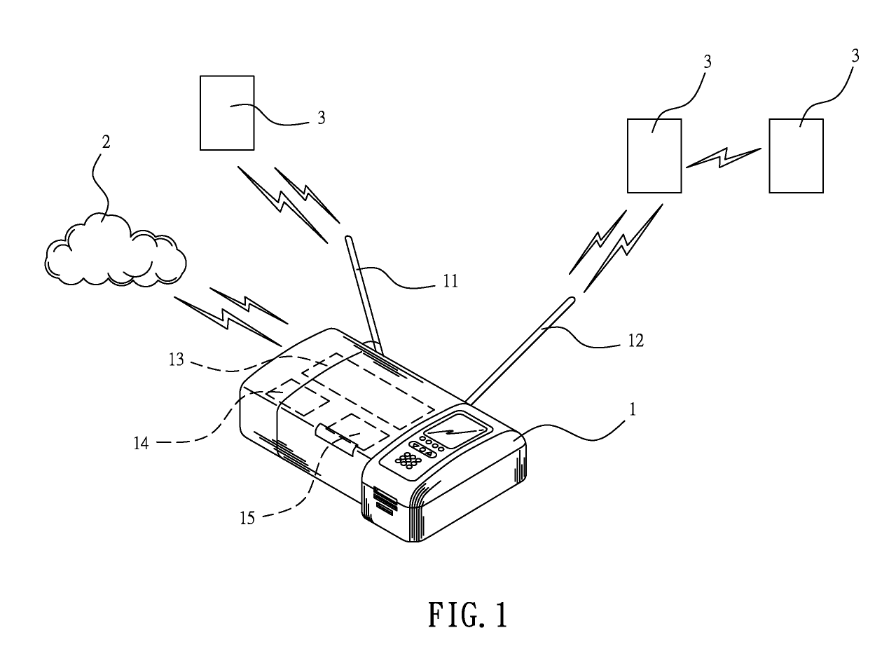

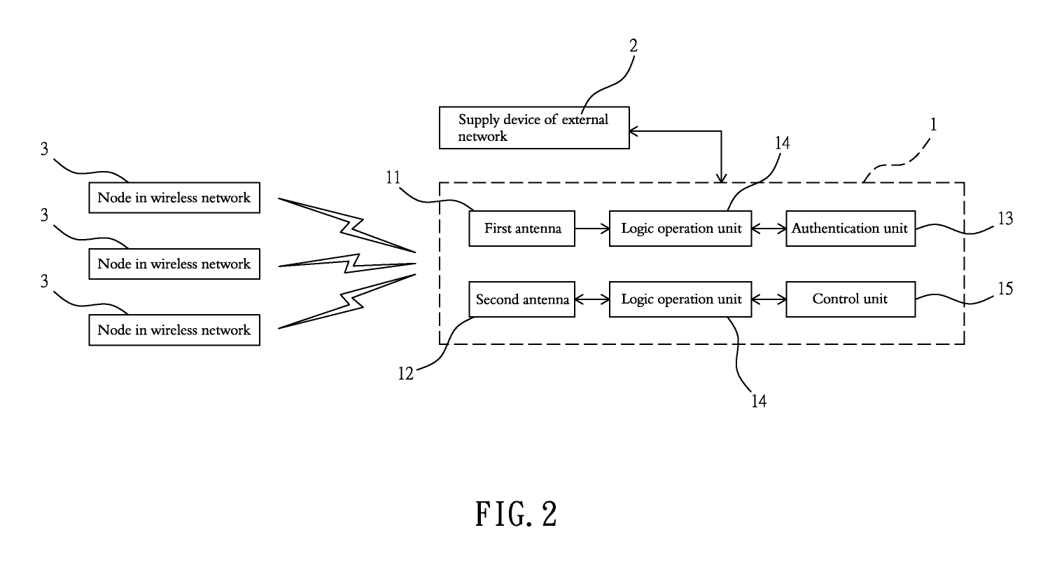

Referring to the “FIG. 1 and FIG. 2” for the schematic diagram of basic configuration for the present invention and the schematic block diagram for the present invention, as shown in the figures: the present invention is an intelligent node-matching and control configuration for the wireless network that can not only simplify and shorten the authentication time for each node in wireless network, but also keep away the interference from the adjacent network segments in order to promote the security and make the functions of administration, transmission, detection and control for a truly private network achievable through the following steps at least:
Step 1:Configure a server mechanism 11 comprised of a first antenna 11, a second antenna 12, an authentication unit 13, a logic operation unit 14 and a control unit 15; wherein, the first antenna 11 is a low-power RF antenna with fixed frequency, network segment and channel that can be used for authentication, the second antenna 12 is a high-power RF antenna that can be used for signal transmission, the authentication unit 13 can be used to generate the relevant ID codes while the ID codes can be at least as follows: PAN ID, Operating Channel, Location ID, House ID, Room ID, Mac address or Device profile to be taken in different types for combination application, and the operation unit 14 is able to process the received information while the control unit 15 can take the transmission signal to perform action and operation instruction.
Step 2: Take the server mechanism 1 to connect a supply device 2 of external network while the server mechanism 1 and the supply device 2 of external network can be interconnected in a manner of cable or wireless transmission.
Step 3: Configure a plurality of nodes in the wireless network for each node in the wireless network to enable a handshaking communication with the first antenna 11; and with the authentication passed (range of authentication 0.3 m˜2 m) by the authentication unit 13, the server mechanism 1 can transmit the relevant information & parameters to the nodes 3 simultaneously so that each node in the wireless network can be interconnected to the server mechanism and operate in cooperation with the second antenna 12 to proceed the signal transmission; for other nodes in the wireless network that have not been authenticated by the first antenna 11 of the server mechanism 1, they will not undertake signal transmission with one another even they are resided to the same frequency band.

Such a configuration, is able to take the foregoing steps to permit an addition of network segment between the server mechanism 1 and the node 3 after having the authentication done by both parties; and undertaking the mutual control & operation together with the action of filtration and isolation by detecting and verifying the ID codes after finishing the action of authentication is available prior to the addition of the independent network domain so that the function to divide the section, group and layer by the combinations of ID code is achievable; moreover, since the server mechanism 1 will add its own serial number into the ID codes when performing the initial authentication and record the information of nodes 3 in the wireless network that have been authenticated at the same time; so, the nodes 3 in the wireless network that have not been self-authenticated will not receive the operating interference even if they have the identical ID codes; consequently, the nodes 3 without having its own serial number will not receive the signal while their adjacent networks will not interfere with one another or create error action.

Furthermore, the server mechanism 1 of the present invention is able to record, delete and update the information of the added nodes 3 in the wireless network; therefore, the functional requirements for the new addition, removal and modification to each node 3 in the wireless network are achievable.

It is concluded from the foregoing preferred embodiments that the present invention, an intelligent node-matching and control configuration for the wireless network, is able to not only simplify and shorten the authentication time for each node in the wireless network, but also keep away the interference from the adjacent network segments in order to promote the security and make the functions of administration, transmission, detection and control for a truly private network achievable; moreover, the creation of the present invention in possession of the novelty and utility is more suitable to meet the need of subscribers that complies with the requisites of application for an invention of patent; therefore, an application for the patent is filed in accordance with the statutes of patent.

Nevertheless, the foregoing preferred embodiments are simply described as some of the better preferred embodiments of the present invention; therefore, it is intended that the description of the preferred embodiments for the present invention illustrates rather than limits the present invention; that is, all the simply equivalent changes and modifications made to the contents disclosed by the present invention and the scope of patent applied for the present invention shall be resided within the scope of patent set forth below for the present invention.

What is claimed is:

1. A configuration to detect and control the wireless network inside a building, comprising the following steps at least:
Step 1: Fix the location of networking device in the building; wherein, the networking device consists of a gateway, a server and a LAN coordinator at least;
Step 2: Mount the networking device at the exit end of network in the building with the gateway linked to the supply device of external network; and
Step 3: Take and erect a plurality of wireless network nodes, equipped with a transmit/receive unit, an indicating unit and a power supply unit, in the building in a manner of irregular distribution while each node of the wireless network can be established the parameters of measurement for the desired linking quality; in addition, each node of the wireless network is interconnected to a LAN coordinator while the nodes within the wireless network are interconnected with one another as well.

2. A configuration to detect and control the wireless network inside a building as claimed in the claim 1; wherein, the gateway and the supply device of external network are linked in a manner of cable or wireless transmission.

3. A configuration to detect and control the wireless network inside a building as claimed in the claim 1; wherein, the LAN coordinator of the networking device is interconnected to the nodes of the wireless network in a manner of wireless transmission

4. A configuration to detect and control the wireless network inside a building as claimed in the claim 1; wherein, the node of wireless network can be further equipped with a detection unit and a control unit.

5. A configuration to detect and control the wireless network inside a building as claimed in the claim 4; wherein, the detection unit can be integrated with the control unit and connected to the network node via cable or erected independently in the building.

6. A configuration to detect and control the wireless network inside a building as claimed in the claim 4; wherein, the control unit is mounted in the detection unit or erected independently in the building.

7. A configuration to detect and control the wireless network inside a building as claimed in the claim 1; wherein, the supply device of the external network is able to provide a route for the optical cable, ADSL or relevant broadband.

8. A configuration to detect and control the wireless network inside a building as claimed in the claim 1; wherein, the transmit/receive unit to each node of the wireless network can be applicable to the ZigBee Wireless Network Communication Protocol.

9. A configuration to detect and control the wireless network inside a building as claimed in the claim 1; wherein, the indicating unit to each node of the wireless network can be a LED or a buzzer.

10. A configuration to detect and control the wireless network inside a building as claimed in the claim 1; wherein, each node of the wireless network can be established the parameters of measurement for the signals (SS) , Bit Error Rate (BER) , Linking Quality Index (LQI), channel (CH) and the upper limit or lower limit of the Wireless Personal Area Network ID (PAN ID) at least.
